(19) United States
(12) Patent Application Publication
(10) Pub. No.: US 2010/0116844 A1
(43) Pub. Date: May 13, 2010

(54) Enhanced Beverage Dispenser

(76) Inventor: Robert Bissinger, Ronkonkoma, NY (US)

Correspondence Address: MCCARTER & ENGLISH, LLP NEWARK, FOUR GATEWAY CENTER, 100 MULBERRY STREET, NEWARK, NJ, 07102, US

(21) Appl. No.: 12/616,402

(22) Filed: Nov. 11, 2009

Related U.S. Application Data
(60) Provisional application No. 61/113,332, filed on Nov. 11, 2008.

(51) Int. Cl. B67D 7/00; B67D 7/78; B01F 3/04

(52) U.S. Cl. 222/1; 99/323.1; 222/129.4; 222/145.6

(57) ABSTRACT

Disclosed herein are systems and methods for an enhanced beverage dispenser. In preferred embodiments, the beverage dispenser includes: (a) a first flow path in which a first amount of a powder is mixed with water proximal a first whipping chamber to form a first supply of beverage; (b) a second flow path in which a second amount of the same powder is mixed with water proximal a second whipping chamber to form a second supply of the same beverage; and (c) dispensing means positioned downstream of both whipping chambers at which the first and second supplies of beverage converge to provide a high dispensing flow rate. In this regard, a lower flow rate is provided for whipping to inhibit over-foaming of the beverage, while a higher dispensing flow rate is provided for quick-filling of a large-volume beverage container.

### CROSS-REFERENCE TO RELATED APPLICATIONS

The present application claims the benefit of priority to U.S. Provisional Patent Application No. 61/113,332, filed Nov. 11, 2008.

### FIELD OF THE INVENTION

The present invention relates generally to improvements for a beverage dispenser, and, more particularly, to systems for dispensing high volumes of a beverage.

### BACKGROUND OF THE INVENTION

It is known in the art to provide machines for dispensing hot whipped beverages, such as cappuccino, hot chocolate, etc. While it is desirable to dispense such beverages at higher flow rates to fill larger volume containers, it may be undesirable to provide a higher flow rate during beverage whipping, because the higher flow rate might induce over-foaming in the beverage. What is needed in the art is an improved beverage dispenser to overcome this and/or other disadvantages of the prior art.

### SUMMARY OF THE INVENTION

Disclosed herein is an improved beverage dispenser for enabling a higher flow rate for dispensing a beverage and a lower flow rate for whipping the beverage upstream of the dispensing.

In a preferred embodiment of the invention, a beverage dispenser system is provided that includes a beverage dispenser. Additionally, the beverage dispenser system may include amounts of a beverage constituent, such as powdered cocoa or cappuccino, and/or one or more containers for receiving the whipped beverage, such as a larger-volume box container and/or a smaller volume container, e.g., a cup.

In some aspects, the beverage dispenser includes a high volume dispense section having a plurality of flow paths. In connection with a first amount of a beverage constituent, a first flow path can be provided with a first whipping assembly for whipping a first supply of a beverage having a first flow rate through the first flow path.

In connection with a second amount of the beverage constituent (for that same beverage), a second flow path can be provided with a second whipping assembly for whipping a second supply of the beverage having a second flow rate through the second flow path. Means are provided for dispensing the first and second supplies at a dispensing flow rate greater than the first and second flow rates individually. In some embodiments, the dispensing flow rate can be the sum of the first and second flow rates, though such is not required. The box container can be positioned in a large volume container receiving area of the beverage dispenser.

In some aspects, the beverage dispenser includes a low volume dispense section, such that the beverage dispenser is capable of filling both a cup and the quick-filling box container. In connection with a third amount of the beverage constituent, a third flow path can be provided with a third whipping assembly for whipping a third supply of a beverage having a third flow rate through the third flow path. Means are provided for dispensing the third supply at a second dispensing flow rate less than the dispensing flow rate of the high volume dispense section. The cup container can be positioned in a small volume container receiving area of the beverage dispenser.

Additional features, functions and benefits of the disclosed beverage dispenser and methods of use shall be apparent from the detailed description which follows, particularly when read in conjunction with the accompanying figure.

### BRIEF DESCRIPTION OF THE DRAWINGS

For a more complete understanding of the present invention, reference is made to the following detailed description of exemplary embodiment(s) considered in conjunction with the accompanying drawings, in which:

FIG. 1 is a front side elevational view of a beverage dispenser system constructed in accordance with an exemplary embodiment of the present invention, a front control panel of a beverage dispenser of the system having been removed to reveal internal components of the beverage dispenser;

FIG. 2 is a right side elevational view of the beverage dispenser system of FIG. 1, a right side panel of a housing of the beverage dispenser having been removed to reveal internal components thereof;

FIG. 3 is a front side elevational view of the front control panel of the beverage dispenser of FIGS. 1 and 2;

FIG. 4 is a perspective view of the beverage dispenser system of FIGS. 1 and 2, the front control panel of the beverage dispenser having been removed to reveal internal components thereof;

FIG. 5 is a perspective view of a vent cap of the beverage dispenser of FIGS. 1, 2, and 4;

FIG. 6 is a perspective view of a mixing bowl of the beverage dispenser of FIGS. 1, 2, and 4;

FIG. 7 is a perspective view of a whipping chamber of the beverage dispenser of FIGS. 1, 2, and 4;

FIGS. 8A and 8B are front and rear perspective view of a whipping disc of the beverage dispenser of FIGS. 1, 2, and 4;

FIG. 9 is a perspective view of a whipping blade of a beverage dispenser constructed in accordance with an alternative embodiment of a beverage dispenser;

FIG. 10 is a perspective view of a twin-feed nozzle of the beverage dispenser of FIGS. 1, 2, and 4; and

FIG. 11 is a cross-sectional view of the twin-feed nozzle taken along section line 11-11 of FIG. 10.

### DETAILED DESCRIPTION OF EXEMPLARY EMBODIMENTS

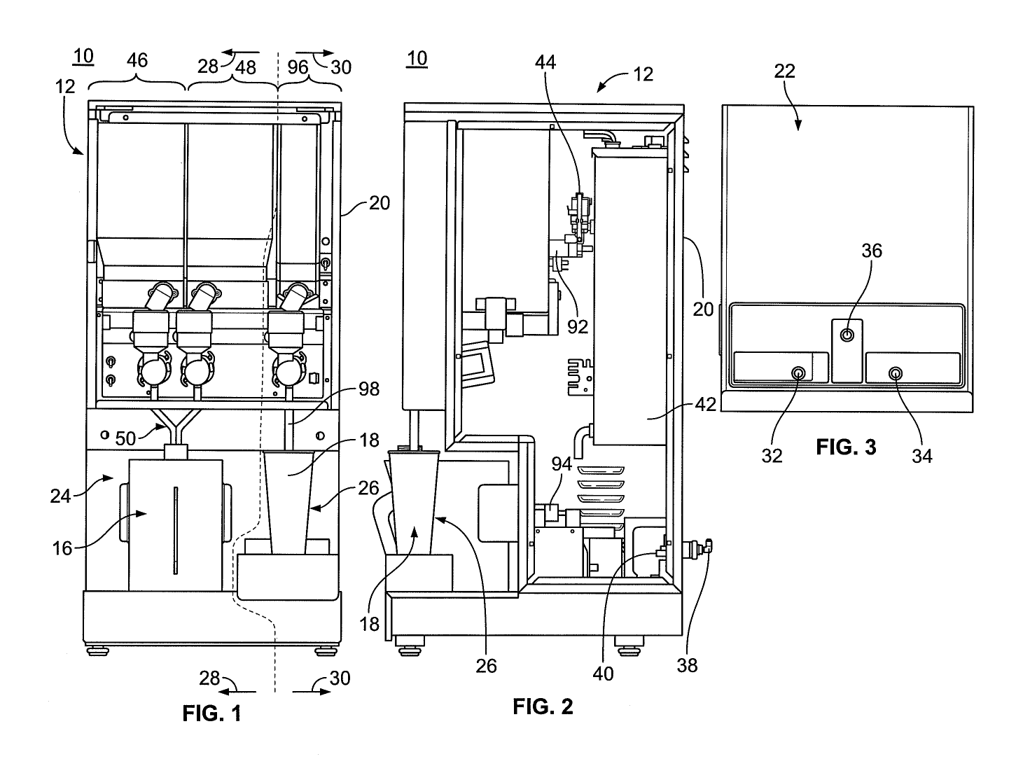

Referring to FIGS. 1-4, a beverage dispenser system 10 is shown constructed in accordance with an exemplary embodiment of the present invention. The beverage dispenser system 10 includes a beverage dispenser 12, and, in some embodiments, is provided with beverage constituent 14a-c, such as a powder, for making cappuccino, hot chocolate, or another whipped beverage. In some embodiments, the beverage dispensing system 10 further includes a plurality of containers, such as a larger volume container, referenced herein as a box 16, and a smaller volume container, referenced herein as a cup 18. In preferred embodiments, the beverage dispenser system 10 is sized, dimensioned, and otherwise configured to fit and sit upon a countertop for in-store use.

The beverage dispenser 12 includes a housing 20 and is provided with a front control panel 22. The beverage dispenser 12 is provided with first and second receiving areas 24, 26 at which the box 16 and the cup 18 may be respectively positioned for fluid communication with a high volume dispense section 28 of the beverage dispenser 12 and a low volume dispense section 30 of the beverage dispenser 12, respectively. The front control panel 22, which is in electrical communication with an electronic control unit (not shown), includes a button, referenced herein as a high volume dispense button 32, for having the electronic control actuate the high volume dispense section 28 of the beverage dispenser 12 for a high-volume outflow of beverage into the box 16. The front control panel 22 further includes a button, referenced herein as a low volume dispense button 34, for having the electronic control actuate the low volume dispense section 30 of the beverage dispenser 12 for a low-volume outflow of beverage to the cup 18. A stop button 36 can be provided for interrupting midstream the outflow of beverage to the box 16 and/or the cup 18. It is contemplated that user interface elements additional and/or alternative to buttons 30, 32, 34 can be provided with the beverage dispenser 12.

Referring to FIG. 2, the beverage dispenser 12 includes a subsystem for delivering a liquid, such as hot (or cold) water, to the high volume dispense section 28 and the low volume dispense section 30. Any subsystem suitable for the purposes herein described can be included. For example, the subsystem can include a water inlet 38 receiving water from external piping, a water valve 40 in communication with the water inlet 38 for controlling the inflow of water, a water tank 42 for storing (and heating) water from the water valve 40 via a conduit (not shown), and a dispensing valve 44 for communication of hot water, for example, from the water tank 42 to the high volume dispense section 28 and the low volume dispense section 30.

Referring to FIGS. 1-4, the high volume dispense section 28 is configured to dispense a beverage at a dispense flow rate into a large volume container, such as the box 16. The high volume dispense section 28 has a plurality of flow paths, at least including a first flow path 46 and a second flow path 48, and further includes a twin-feed nozzle 50 in fluid communication with the first and second flow paths 46, 48. Whipping of first and second supplies of the beverage occurs along the first and second flow paths 46, 48. The high volume dispense section 28 enables a higher dispense flow rate to the box 16, while providing lower individual flow rates through the first and second flow paths 46, 48. In this regard, a higher, quick-filling dispense flow rate is provided, while a lower, upstream flow rate is provided, thereby minimizing over-foaming of the beverage during whipping.

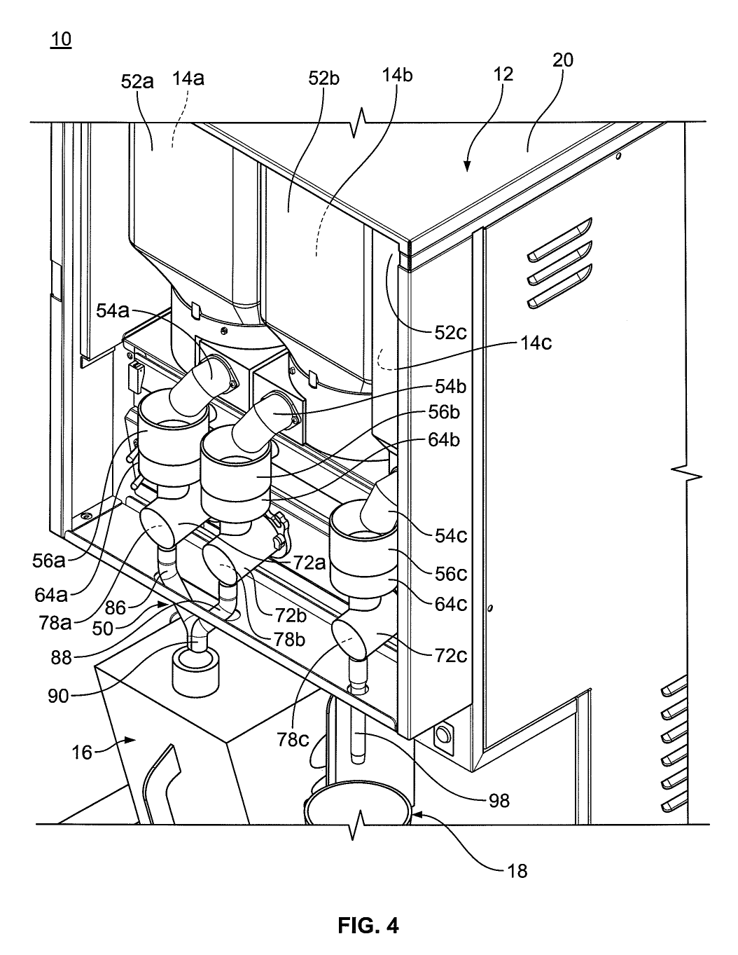

Referring to FIGS. 1 and 4, the first flow path 46 includes a first reservoir, such as a first hopper 52a, which is configured to contain a first amount of beverage constituent 14a, preferably in powder form. A first hopper outlet 54a is in communication with the first hopper 52a for directing a flow of the first amount of beverage constituent 14a to a vent cap 56a for further communication to a first mixing bowl 64a, where the first amount of the beverage constituent 14a, e.g., cocoa, is mixed with a liquid, e.g., hot water, to form a first supply of the beverage.

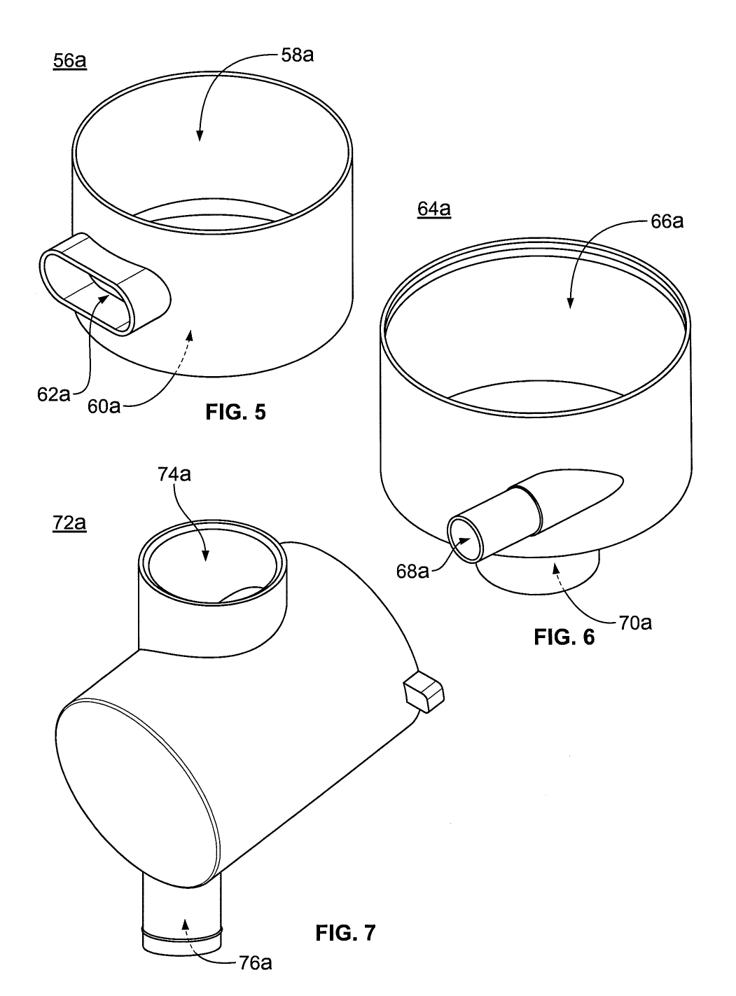

Referring to FIGS. 1, 4, 5, and 6, the vent cap 56a can include a first vent cap inlet 58a for receiving the first amount of beverage constituent 14a and a first vent cap outlet 60a for communicating the first amount of beverage constituent 14a to the first mixing bowl 64a and for receiving steam from the first mixing bowl 64a to vent to atmosphere via a first steam relief opening 62a. In preferred embodiments, the vent cap 56a attaches to the mixing bowl 64a and is used to draw away water vapor from the hot water, which may have a temperature of one-hundred-eighty degrees Fahrenheit, for example.

The first mixing bowl 64a can include a first mixing bowl inlet 66a for receiving the first amount of beverage constituent 14a from the first vent cap outlet 60a and for sending steam thereto. The first mixing bowl 64a includes a first feed 68a for receiving hot water from the water tank 42 and a first mixing bowl outlet 70a for communication of the first supply of beverage from the first mixing bowl 64a to a first whipping chamber 72a.

In preferred embodiments of the invention, the mixing bowl 64a is an open bowl-like device that receives the hot water from the feed 68a. The feed 68a preferably comprises a side port, which directs the water tangentially into a circular swirling pattern. Into this, the dry powder, for example, is introduced from above. The powder drops through the open vent cap 56a and into the bottom of the first mixing bowl 64a. The water and powder drains through the first mixing bowl outlet 70a, e.g., a lower opening at the bottom of the first mixing bowl 64a, and into the first whipping chamber 72a.

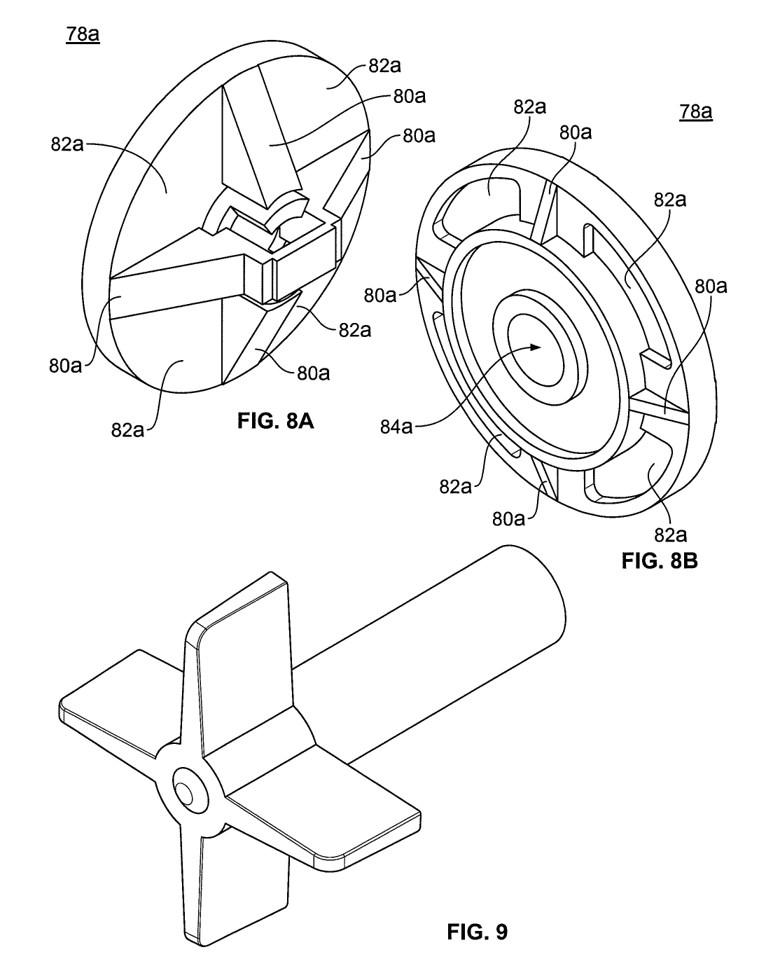

Referring to FIGS. 1, 4, 7, 8A, and 8B, the first whipping chamber 72a is provided with a first whipping chamber inlet 74a for receiving the first supply of beverage, and a first whipping chamber outlet 76a for communicating the first supply of beverage in a whipped form to a first inlet segment 86 of the twin-feed nozzle 50.

Whipping means, such as a first whipping disc 78a, is positioned within the whipping chamber 72a. The whipping disc 78a preferably includes a series of smooth protrusions 80a and grooves 82a for low turbulence mixing to minimize over-foaming. The first whipping disc 78a is provided with a central opening 84a for receiving a motor shaft (not shown) that drives rotation of the first whipping disc 78a. The whipping means provided with the whipping chamber 72a can comprise more than one whipping discs 78a, e.g., a pair may be included. The whipping disc(s) 78a provide a gentle mixing action, providing reduced foam build-up before dispensing into the waiting container. Additional and/or alternative whipping means is contemplated. For example, referring to FIG. 9, therein is shown a whipping blade and shaft in accordance with an alternative embodiment of the present invention.

In preferred embodiments of the invention, the first whipping chamber 72a comprises a closed cylindrical chamber. The first whipping chamber inlet 74a comprises a top opening to accept the pre-mixed product, which gets fully mixed by a whipping action created by the spinning of the first whipping disc(s) 78a located centrally within the first whipping chamber 72a. The fully mixed and whipped product drains out of the first whipping chamber outlet 76a, which comprises a bottom opening, and into a nozzle, such as a first inlet segment 86 of a twin-feed nozzle 50. The nozzle 50 directs the beverage into a waiting large-volume container, such as box 16, placed below the nozzle.

Referring to FIGS. 1 and 4, the high volume dispense section 28 further includes a second flow path 48, which is preferably similar to the first flow path 46. For example, the second flow path 48 is provided with a second reservoir, e.g., a second hopper 52b, configured to have a second amount of the beverage constituent 14b. In this regard, mixed in the second flow path 48 is a second supply of that same beverage which was mixed in the first flow path 46. The second flow path 48 is provided with a second hopper outlet 54b in communication with the second hopper 52b and a second vent cap 56b, which diverts the second amount of beverage constituent 14b to a second mixing bowl 64b and further diverts steam to atmosphere. The second amount of beverage constituent 14b mixes with hot water in the second mixing bowl 64b to form the second supply of the beverage. The second supply is received by the second whipping chamber 72b, where the second supply is whipped by a second whipping disc 78b and communicated to the second inlet segment 88 of the twin-feed dispense nozzle 50. It shall be understood that components provided with the second flow path 48, e.g., components 52b, 54b, 56b, 64b, 72b, and 78b are similar in design and construction as components 52a, 54a, 56a, 64a, 72a, and 78a described herein.

Referring to FIGS. 1, 4, 10, and 11 the preferred dispensing means for the illustrated configuration includes a twin-feed nozzle 50 in fluid communication with two flow paths 46, 48. It shall be understood that the high volume dispense section 28 can further include flow paths additional to the two flow paths 46, 48 and that the dispensing means can include inlet segments in addition to inlet segments 86, 88 for communication with said additional flow paths. For example, the high volume dispense section 28 might include four flow paths (with four amounts of the beverage constituent) provided to further increase the dispensing flow rate of beverage into the large volume container, e.g., into the box 16.

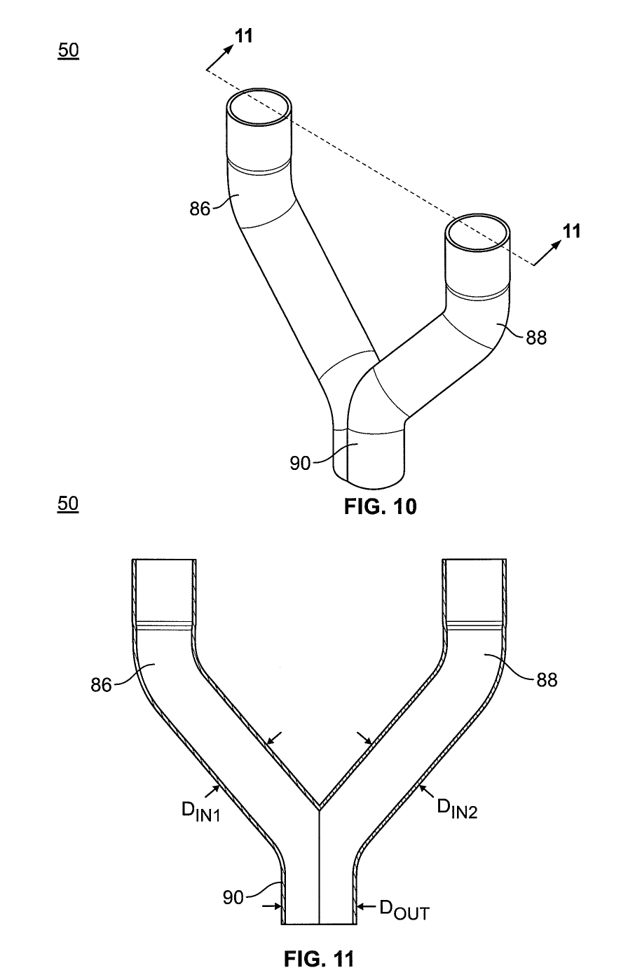

Referring to FIGS. 10 and 11, the illustrated twin-feed nozzle 50 includes a downstream segment 90 receiving the first and second supplies of the beverage from the first and second inlet segments 86, 88, respectively. The twin-feed nozzle 50 is preferably configured such that the first supply of the first inlet segment 86 and the second supply of the second inlet segment 88 converge. In some embodiments, an internal diameter D_{OUT} of the downstream segment 90 is greater than an internal diameter D_{IN1} of the first inlet segment 86 and/or is greater than an internal diameter D_{IN2} of the second inlet segment 88. In some embodiments of the invention, A(D_{OUT})=A(D_{IN1})+A(D_{IN2}), where A represent a cross-sectional area of a pipe, and where cross-sectional area A is a function of a diameter. However, such is not required. Flow rate can be controlled by any suitable approach known in the art. For example, pressure can be increased to increase velocity.

In preferred embodiments of the invention, the same components are used in each of the first and second flow paths 46, 48, such that the high volume dispense section 28 includes two of each components, and the first and second flow paths 46, 48 are arranged in a parallel path in order to obtain increased flow rate to the box 16. A twin-feed nozzle 50 is provided that combines the two product streams into a common dispensing stream for the waiting container spout. In some embodiments, three, four, or more parallel paths can be provided with a multi-feed nozzle to further increase flow rate to a higher-volume container.

It is contemplated that dispensing means can be provided in which the first supply of the beverage and the second supply of the beverage are not mixed with one another. For example, the dispensing means can include a first nozzle for the first flow path 46 and, spaced apart therefrom, a second nozzle for the second flow path 48, wherein the first and second volumes of beverage do not contact one another until they have been received in the large container, e.g., the box 16.

Referring to FIGS. 1 and 4, the beverage dispenser 12 can be provided with a low volume dispense section 30 in addition to the high volume dispense section 28. In this regard, the beverage dispenser system 10 might be provided with a smaller container, e.g., a cup 18, to be positioned at a cup receiving area 26 for receiving a beverage from an additional flow path, e.g., a third flow path 96. The third flow path 96 is preferably provided with a third amount of the beverage constituent 14c, such that the machine is capable of both high- and low-volume dispensing of the same beverage via high and low volume dispense sections 28, 30, respectively.

Continuing with reference to FIGS. 1 and 4, the third flow path 96 of the low volume dispense section 30 is preferably similar to the first and second flow paths 46, 48. For example, the third flow path 96 is provided with a third reservoir, e.g., a third hopper 52c, configured to have a third amount of the beverage constituent 14c. In this regard, a third supply is mixed in the third flow path 96. The third supply is preferably that same beverage of the first and second supplies, but it can be different, as it is not combined with the first and second supplies. The third flow path 96 is provided with a third hopper outlet 54c in communication with the third hopper 52c and a third vent cap 56c, which diverts the third amount of beverage constituent 14c to a third mixing bowl 64c and further diverts steam to atmosphere. The third mixing bowl 64c receives hot water that mixes therein with the third amount of the beverage constituent 14c to form the third supply. The third supply is received by the third whipping chamber 72c, where the third supply is whipped by third whipping disc(s) 78c and communicated to a nozzle, referenced herein as a cup dispense nozzle 98, for dispensing the third volume to a smaller container, e.g., the cup 18. It shall be understood that components provided with the third flow path 96, e.g., components 52c, 54c, 56c, 64c, 72c, and 78c are similar in design and construction as components 52a, 54a, 56a, 64a, 72a, and 78a described herein.

Referring to FIG. 2, the beverage dispenser 12 can include additional and/or alternative features. For example, the beverage dispenser 12 can be provided with one or more detection sensors 94 for continuously polling the receiving areas 24, 26 to determine the presence or absence of the corresponding one of the containers 16, 18 and to communicate same to the electronic control (not shown). If a user actuates one of the dispense buttons 32, 34, the electronic control would nevertheless prevent dispensing of the corresponding volume of beverage if the corresponding one of the receiving areas 24, 26 was empty, for example.

The detection sensors 94 can be characterized as a safety feature, and guide brackets can be used in connection with such feature to assist a user in positioning container 16, 18 in the correct location of either of the container receiving areas 24, 26. The detection sensors 94, which can comprise proximity sensors, cooperate with the guide brackets to assure that the box container 16, for example, is positioned properly to accept the dispensed drink and not spill outside the container.

The beverage dispenser 12 can be provided with a plurality of out-of-product sensors 92 for continuously polling the hoppers 52a-c to determine the presence or absence of beverage constituent. If a user actuates one of the dispense buttons 32, 34, the electronic control would nevertheless prevent dispensing of the corresponding supply of beverage under certain circumstances. At the low volume dispense section 30, if the user actuates the low volume dispense button 34, the electronic control would prevent dispensing of the third supply of beverage, if the out-of-product sensor corresponding to the hopper 52c sends an out-of-product signal. At the high volume dispense section 28, if the user actuates the high volume dispense button 32, the electronic control would prevent dispensing of both the first and second supplies of beverage, if the out-of-product sensor corresponding to any one of the hoppers 52a and 52b sends an out-of-product signal. In this regard, even though one of hoppers 52a and 52b may not have “run-out” of beverage constituent, a combination of the first and second supplies would be diluted if permitted to continue, and thus dispensing of a diluted beverage is prevented. The out-of-product sensors 92 can comprise proximity sensors. In the high volume dispense section 28, for example, the sensors 92 monitor the level of powder inside each of the two powder hoppers, to make sure “either” hopper does not run out of powder during the dispensing of the drink. This way the correct strength, e.g., drink ratio, will be produced consistently.

Thus, herein has been described an enhanced beverage dispenser, comprising a machine with capability of filling a large storage container (e.g., a ninety-six ounce cardboard box dispenser), while limiting the amount of product foaming to gain an optimal filling ratio. A fast-fill counter-top beverage dispenser is provided that will dispense a high volume of finished product into carry-out containers, for example, with small closable openings, without excessive foaming, while filling up to about ninety to ninety-five percent of the available volume, for example. In preferred embodiments, the same machine that provides fast-fill capability, can be used to supply smaller cup sized servings, e.g., eight to twelve ounces, for example, with normal foam head of about one-half inch high. In preferred embodiments, the high volume dispense section 28 assures that dispensing into the box 16 will not occur when the box is improperly positioned below the spout, e.g., nozzle 50. The dispensing unit, in preferred embodiments, will cease if powdered product runs low enough, in at least one of the first and second flow paths, to produce a drink not of a specified powder to water ratio.

In preferred embodiments of the invention, a first dispensing flow rate of the high volume dispense section 28 can be about three ounces per second, for example, and the second dispensing flow rate of the low volume dispense section 30 can preferably be about one and three-tenths (1.3) of an ounce per second. In preferred embodiments, the hoppers 52a, 52b of the high volume dispense section 28 are provided with about twenty-three pounds of product, e.g., powder or other beverage constituent, and the hopper 52c of the low volume dispense section 30 are provided with about seven pounds of product.

In preferred embodiments of the invention, the beverage dispenser system 10 presents a dispensed beverage, e.g., hot chocolate, by thoroughly mixing liquid, with minimized powder residue within the liquid, and a visible head on the surface of the beverage of approximately one-quarter inch to approximately one-half inch.

Regarding the low volume dispense section 30, for example, this effect is preferably achieved on the cup size section of the machine, for example, by mixing hot water and powder into an open mixing bowl located above the dispense nozzle. The beverage dispenser machine may also have a product guide in between the hoppers and the mixing bowl. A secondary whipping of the hot water/powder mix occurs in the whipping chamber, just below the mixing bowl, and the final beverage product dispenses out of the cup dispense nozzle into the waiting cup. Pre-calculated water flow rates, powder dispensing rates, whipping disc (or blade) design and speed, all assures a desirable beverage.

Regarding the high volume dispense section 28, production of a larger filled portable beverage container of a beverage, e.g., hot chocolate, presents different water and powder feed rates as well as a different mixing system. Larger volumes of mixed product tend to foam-up and overflow an enclosed container before a percentage of its total volume has been filled with liquid, and it is preferably to achieve up to ninety percent of the available volume of the container, e.g. box 18, being filled without foam overflowing the container spout. Inhibiting over-foaming can be accomplished, at least in part, by including whipping disc(s) in the secondary chamber, e.g., the whipping chamber 72a, for a mixing action that is gentler than that typically provided by a whipping blade. However, a mixing disc is not required, and any suitable whipping means, including a whipping blade, for example, can be included.

Inhibiting over-foaming can also be accomplished, at least in part, by providing the parallel flow paths. To fill large containers in relatively short periods of time, the fill rate, e.g., flow rate, might be doubled, for example, by using two hopper/mix chamber sections that feed into a two-to-one dispensing tube. Each of the large hoppers preferably contains about ten pounds of powder (e.g., about twenty three pounds for the two together) and the smaller hopper contains five pounds of powder (e.g., about seven pounds).

On the high volume dispense section 28, there are two separate hoppers used, and, if either one runs out of product, then dispensing is interrupted, because otherwise the dispensed drink would be diluted and the customer would not realize this until the user sampled the drink some time after leaving the store. To prevent this from happening an “out of product” sensor is used on each hopper that will stop the dispense operation if the powder level in either hopper drops below a certain point.

The design preferably also includes protection against the unit dispensing without the container being in place. A proximity sensor, along with a guide bracket, is used to assure the portable container is positioned properly to accept the dispensed drink, and not spill outside the container.

The design also preferably contains buttons to control the machine, these may include a high volume dispense button for activating dispensing the beverage from the high volume dispense section, a cup dispense button for activating dispensing the beverage from the cup size section and a stop button to either stop the machine entirely or the dispensing of a specific beverage.

The above aspects of the present invention have been given by way of illustrative example. While various embodiments of the invention have been described herein, it should be apparent, however, that various modifications, alterations and adaptations to those embodiments may occur to persons skilled in the art with the attainment of some or all of the advantages of the present invention. The disclosed embodiments are therefore intended to include all such modifications, alterations and adaptations without departing from the scope and spirit of the present invention as set forth in the appended claims.

What is claimed is:

1. A beverage dispenser system for providing a lower flow rate for whipping a beverage and a higher flow rate for dispensing the beverage, comprising:
a first flow path provided with a first whipping assembly for whipping a first supply of a beverage having a first flow rate through said first flow path;
a second flow path provided with a second whipping assembly for whipping a second supply of the beverage having a second flow rate through said second flow path; and
means for dispensing a converged supply of the first and second supplies at a dispensing flow rate greater than said first flow rate individually and greater than said second flow rate individually.

2. The beverage dispenser system of claim 5, including the first amount of the beverage constituent and the second amount of the beverage constituent.

3. The beverage dispenser of claim 1, wherein said dispensing means comprises a Y-connector.

4. The beverage dispenser of claim 1, where said dispensing means comprises a twin-feed nozzle.

5. The beverage dispenser system of claim 1, wherein said first flow path is provided with a first mixing chamber upstream of said first whipping chamber, and wherein said second flow path is provided with a second mixing chamber upstream of said second whipping chamber.

6. The beverage dispenser system of claim 5, including a first reservoir having a first amount of a beverage constituent for the beverage and in communication with said first mixing chamber, and further including a second reservoir having a second amount of the beverage constituent for the beverage and in communication with said second mixing chamber.

7. The beverage dispenser system of claim 6, wherein said first reservoir comprises a first hopper, and wherein said second reservoir comprises a second hopper.

8. The beverage dispenser system of claim 6, wherein said first mixing chamber is configured to mix liquid with the first amount of the beverage constituent to form the first supply of the beverage, and wherein said second mixing chamber is configured to mix liquid with the second amount of the beverage constituent to form the second supply of the beverage.

9. The beverage dispenser system of claim 8, including the first amount of the beverage constituent and the second amount of the beverage constituent.

10. The beverage dispenser system of claim 1, comprising a third flow path provided with a third whipping assembly for whipping a third supply and further provided with a nozzle for dispensing the third supply.

11. The beverage dispenser system of claim 10, including a first container having a first container volume and in fluid communication with said dispensing means, said first container configured to receive beverage at said dispensing flow rate, and further including a second container having a second container volume less than said first container volume and in fluid communication with said third flow path, said second container configured to receive the third volume at a second dispensing flow rate less than said dispensing flow rate.

12. The beverage dispenser of claim 11, wherein said first container comprises a box, and wherein said second container comprises a cup.

13. A beverage dispenser system, comprising:
a first flow path provided with a first hopper for a first amount of a powder, a first mixing bowl for mixing water with the first amount of the powder to form a first supply of a beverage, and a first whipping chamber for whipping the first supply of the beverage;
a second flow path provided with a second hopper for a second amount of the powder, a second mixing bowl for mixing water with the second amount of the powder to form a second supply of the beverage, and a second whipping chamber for whipping the second supply of the beverage;
a third flow path provided with a third hopper for a third amount of the powder, a third mixing bowl for mixing water with the third amount of the powder to form a third supply of the beverage, and a third whipping chamber for whipping the third supply of the beverage;
a first container and at least one nozzle for dispensing converged beverage from said first and second flow paths into said first container at a first dispensing flow rate;
a second container and at least one nozzle for dispensing the beverage from said third flow path into said second container at a second dispensing flow rate less than said first flow rate.

14. The beverage dispenser system of claim 13, including the first, second, and third amounts of the powder.

15. The beverage dispenser system of claim 14, wherein said first flow path is configured to have the first supply of beverage flow therethrough at a first flow rate, wherein said second flow path is configured to have the second supply of beverage flow therethrough at a second flow rate, and wherein said first dispensing flow rate is greater than said first flow rate and greater than said second flow rate.

16. The beverage dispenser system of claim 14, wherein said first container comprises a box, and wherein said second container comprises a cup.

17. A method of inhibiting over-foaming of a beverage dispensed into a high-volume container, comprising:
providing first and second flow paths;
whipping a first supply of a beverage traveling a first flow rate along the first flow path;
whipping a second supply of the beverage traveling a second flow rate along the second flow path; and
converging the first and second supplies of the beverage to form a combined supply of the beverage; and
dispensing the combined supply of the beverage into a container at a dispensing flow rate greater than the first and second flow rates.

18. The method of claim 17, comprising:
upstream of whipping the first supply of the beverage, mixing liquid with a first amount of a beverage constituent for the beverage to form the first supply of the beverage; and
upstream of whipping the second supply of the beverage, mixing liquid with a second amount of the beverage constituent for the beverage to form the second supply of the beverage.

19. The method of claim 17, comprising
providing a third flow path; and
whipping a third supply of the beverage traveling a third flow rate along the third flow path; and
dispensing the third supply of the beverage into a second container at a second dispensing flow rate less than the dispensing flow rate.

20. The method of claim 19, wherein the container has a first container volume, and wherein the second container has a second container volume less than the first container volume.
